(19) United States
(12) Patent Application Publication
(10) Pub. No.: US 2019/0012718 A1
(43) Pub. Date: Jan. 10, 2019

(54) MULTI-WINDOW TIME-AWARE PERSONALIZED RECOMMENDATION SYSTEM

(71) Applicant: Capillary Technologies International Pte Ltd., Singapore (SG)

(72) Inventors: Satya Gautam VADLAMUDI, Hyderabad (IN); Shashi KUMAR, Bommanhalli (IN); Sanket SAHU, Bangalore (IN); Arjit MALVIYA, Ambikapur (IN); Pravanjan CHOUDHURY, Bangalore (IN)

(73) Assignee: Capillary Technologies International Pte Ltd., Singapore (SG)

(21) Appl. No.: 15/950,259

(22) Filed: Apr. 11, 2018

(30) Foreign Application Priority Data
Jul. 5, 2017 (IN) 201741023671

(51) Int. Cl. G06Q 30/06; G06F 17/30; G06F 17/18

(52) U.S. Cl. CPC G06Q 30/0631; G06F 17/30867; G06F 17/18; G06F 17/3053; G06F 17/30876

(57) ABSTRACT

A multi-window time-aware personalized recommendation system and method is provided. The system includes a memory having computer-readable instructions stored therein. The system further includes a processor configured to access purchase history of one or more users and to select a pair of items purchased by the one or more users based on the purchase history. The processor is further configured to determine a contributory affinity value between a first item and a second item of the selected pair of items for each of the one or more users. The contributory affinity value is determined based on a first time-decay function and a second time-decay function associated with purchase times of the first and second items. In addition, the processor is configured to combine the contributory affinity values for each of the one or more users to estimate the affinity value between the first and second item across multiple time-windows.

### PRIORITY STATEMENT

The present application hereby claims priority under 35 U.S.C. § 119 to Indian patent application number 201741023671 filed 5 Jul. 2017, the entire contents of which are hereby incorporated herein by reference.

### FIELD

Embodiments of the invention relate generally to a recommendation system and more particularly to a personalized recommendation system based on time-aware methods and functions.

### BACKGROUND

With ever increasing growth in the field of e-commerce, shopping online has caused product option overload for the customers. In general, the customers or online shoppers are provided with large number of choices for the products thereby making it difficult for the shoppers to effectively choose the products they are exposed to. To overcome this option overload, several recommendation techniques have been developed. Some product recommendation systems track past actions of a group of customers to make a recommendation to an individual member of the group. In some cases, this may improve the likelihood of a customer purchase by generating a list of products that are most relevant to a customer. In addition, certain recommendation techniques are used to generate recommendations for offline retail stores. Such techniques may use retail store data to generate recommendations such as targeted promotional campaigns.

Some of the existing recommender systems use content based filtering and collaborative filtering, apart from various other hybrid methods. Pure content-based systems operate by attempting to identify items which, based on an analysis of item content, are similar to items that are known to be of interest to the user. Further, in a pure collaborative-based system, items are recommended to users based on the interests of a community of users, without any analysis of item content.

However, the existing recommender systems still require improvements to make recommendation methods more effective and applicable to a broad range of applications. Such systems need enhancements to be more effective so that they can be applied broadly for targeted marketing, both online and offline. In addition, most of the existing techniques are not as time-aware as they should be, do not focus on the choice of time-windows for training and/or learning relationships between products and users, and also are resource (e.g., time, memory) consuming, which presents opportunity in terms of improving the effectiveness as well as the scalability and/or resource optimization.”

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Example embodiments provide a multi-window time-aware personalized recommendation system.

Briefly, according to an example embodiment, a multi-window time-aware personalized recommendation system is provided. The system includes a memory having computer-readable instructions stored therein. The system further includes a processor configured to access purchase history of one or more users and to select a pair of items purchased by the one or more users based on the purchase history. The processor is further configured to determine a contributory affinity value between a first item and a second item of the selected pair of items for each of the one or more users. The contributory affinity value is determined based on a first time-decay function and a second time-decay function associated with purchase times of the first and second items. In addition, the processor is configured to combine the contributory affinity values for each of the one or more users to estimate the affinity value between the first and second item.

According to another example embodiment, a method for generating personalized recommendations for a user is provided. The method comprises accessing purchase history of one or more users of an establishment and selecting an item training data set for determining item-item affinity for the item training data set. The method further comprises identifying a plurality of item pairs for each user in the item training data set based upon the purchase history of the respective user. In addition, the method comprises determining a contributory affinity value between a first item and a second item of each of the item pairs for each user. The contributory affinity value is determined based on a first time-decay function and a second time-decay function associated with purchase times of the first and second items. The method also comprises combining the contributory affinity values for each user to estimate the affinity value between the first and second item of each of the item pairs. Furthermore, the method comprises generating a personalized item ranking of each of the plurality of items for each user based on contribution of affinity of each item in the purchase history of the respective user and generating personalized recommendations for each user based on the generated item ranking of each of the plurality of items.

According to yet another example embodiment, a multi-window time-aware personalized recommendation system is provided. The system includes a memory having computer-readable instructions stored therein. The system also includes a processor configured to access purchase history of one or more users and to apply a time-decay based item-item collaborative filtering to a plurality of items based upon the purchase history of each of the one or more users. The processor is further configured to estimate affinity values between pairs of items for each of the one or more users. Furthermore, the processor is configured to generate personalized item ranking for each of the plurality of items for each user based on contribution of affinity of each item in the purchase history of the respective user and generate personalized recommendations for each of the one or more users based on the generated item ranking.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating a multi-window time-aware personalized recommendation system, according to the aspects of the present technique;

FIG. 2 illustrates an example process for generating personalized recommendations for a user using the multi-window time-aware personalized recommendation system of FIG. 1,

FIGS. 3-A through FIG. 3-D illustrate example time-decay functions with varying parameters, according to the aspects of the present technique;

FIGS. 4-A through FIG. 4-D illustrate example variations of the time-decay functions, according to the aspects of the present technique; and

FIG. 5 is a block diagram of an embodiment of a computing device in which the modules of the multi-window time-aware personalized recommendation system, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like manner (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The device(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner Software and data may be recorded in one or more computer-readable storage media.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

At least one example embodiment is generally directed to a multi-window time-aware personalized recommendation system and method for generating personalized product recommendations based upon a user's purchase history. Example embodiments of the present technique provide a time-aware based heuristic approach for generating personalized recommendations for users that enhances user-engagement and sales of an establishment such as a retail store.

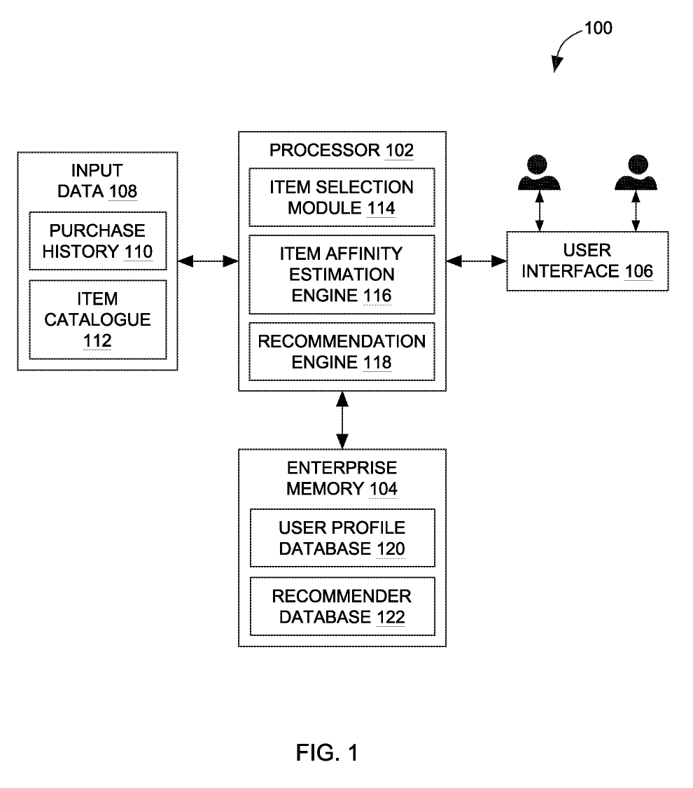

FIG. 1 is a block diagram illustrating a multi-window time-aware personalized recommendation system 100 configured to generate personalized product recommendations for users of an establishment such as a retail store. The recommendation system 100 includes a processor 102, an enterprise memory 104 and a user interface 106.

In the illustrated embodiment, the processor 102 is configured to receive input data 108 for an establishment such as a retail store. The input data 108 may include purchase history 110 of one or more users/shoppers of the establishment and an item catalogue/item details 112 of the items available for sale in the establishment. The processor 102 is configured to generate personalized item recommendations for each of the one or more users based upon the purchase history 110. Such personalized recommendations are generated using an item-to-item collaborative filtering technique that will be described in detail below. The processor 102 further includes an item selection module 114, an item affinity estimation engine 116 and a recommendation engine 118.

The item selection module 114 is configured to select a pair of items purchased by the one or more users based on the purchase history 110. Here, the item selection module 104 is configured to select the pair of items from a plurality of items available in a retail store, listed on a web portal of a retail store, or combinations thereof. The purchase history 110 may be available to the processor 102 in real-time. In another embodiment, the purchase history 110 may be stored and accessed from a memory such as the enterprise memory 104. The purchase history 110 may include data such as transaction details, shopping cart activity, page views of an online web portal, product enquiries, searches, among others.

In a further embodiment, the item selection module 114 is configured to select an item training data set having a plurality of pairs of items. In addition, an item-item affinity is determined and a plurality of item pairs for each user are identified for the selected item training data set.

The item affinity estimation engine 116 is configured to determine a contributory affinity value between the selected pair of items for each of the one or more users. As used herein, the term “contributory affinity value” for a pair of items (e.g., a first item and a second item) refers to a value corresponding to an estimated propensity with which the second item is bought by the customers who bought the first item. In this embodiment, the item affinity estimation engine 116 is configured to determine the contributory affinity value based on a first time-decay function and a second time-decay function associated with purchase times of the first and second items.

In some embodiments, the enterprise memory 104 is configured to store item data, transaction history and time-decay parameters for the first and second time-decay functions over a period of time. In the illustrated embodiment, the enterprise memory 104 includes a user profile database 120 and a recommender database 122. The user profile database 120 stores account-specific information about users over a period of time. The data stored for each user may include information that can be used to generate personalized recommendations for the user. Such information may include the user's purchase history, date of purchase, the user's item ratings profile, current contents of the user's personal shopping cart, a listing of items that were purchased recently or removed from the shopping cart(s) without being purchased and so forth. In an embodiment, where a user has multiple shopping carts, the purchase history for that user may include information about each of the shopping carts used to make each purchase. It should be noted that such information allows to generate recommendations that are specific to a particular shopping cart.

The recommender database 122 stores parameters associated with the time-decay functions such as the first time-decay function and the second time-decay functions. These parameters may be accessed and utilized by the item affinity estimation engine 116 to generate the personalized recommendations for the users.

In an embodiment, the item affinity estimation engine 116 is configured to estimate the first time-decay function ƒ1(x) based upon a time difference between purchases of the first item and the second item, in accordance with the relationship:

ƒ1(x)=1−1/(1+ê(a1−b1*x)) (1)

Similarly, the item affinity estimation engine 116 is configured to estimate the second time-decay function ƒ2(x) based upon a time difference between a reference time and a maximum of the purchase time of the first and second items, in accordance with the relationship:

ƒ2(x)=1−1/(1+ê(a2−b2*x)) (2)

Where: a1 and b1 are parameters associated with the decay of the first time-decay function ƒ1(x); and

a2 and b2 are parameters associated with the decay of the second time-decay function ƒ2(x).

In some examples, the value of the first and second time-decay functions is between 0 and about 1 and this range is substantially independent of input values and parameter values. In one embodiment, the item affinity estimation engine 116 is configured to adjust parameters of the first and second time-decay functions such that the first and second time-decay functions have a concave shape, a convex shape, or a combination thereof.

Further, the item affinity estimation engine 116 is configured to combine the contributory affinity values for each of the one or more users to estimate the affinity value between the first and the second item. In some embodiments, the item affinity estimation engine 116 is configured to estimate the contributory affinity value (A1) between the first item i1 and the second item i2 purchased by a user at time t1 and t2 respectively in accordance with the relationship:

A1=ƒ1(|t1−t2|)*ƒ2(|tƒ−max(t1, t2)|) (3)

### Where

ƒ1 and ƒ2 are the first and second time-decay functions respectively; and

tƒ is the reference time.

It should be noted that for each user, multiple values of A1 are estimated corresponding to the user's purchase of the first item i1 and the second item i2 at different points in time. The item affinity estimation engine 116 is configured to estimate a representative affinity value (RA1) using the multiple A1 values for the corresponding user. The representative affinity value may be a maximum value of A1's for that user, or an average value, or a minimum value, or a latest value. In operation, the representative affinity value (RA1) is estimated for the first item i1 and the second item i2 for all users for a given time-window. Such values are then summed up to determine the window affinity value (WA1) for that time-window. In some embodiments, for multiple time windows, final affinity value (FA) between the first item i1 and the second item i2 is estimated as a weighted combination of all individual window affinity values.

Further, the item affinity estimation engine 116 is configured to generate a personalized item ranking of each of the plurality of items for each user based on contribution of affinity of each item in the purchase history of the respective user to that of all items in a catalogue that are eligible for recommendation. In an embodiment, the contribution of the first item i1 purchased at a time t1 to each of the other items ik is estimated in accordance with the relationship:

FA(i1, ik)*ƒ3(|tƒ−t1|) (4)

### Where:

FA(i1, ik) is affinity between i1 and k; tƒ is a reference time and

ƒ3(x) is a time-decay function in accordance with the relationship:

ƒ3(x)=1−1/(1+ê(a3−b3*x)) (5)

### Where:

a3 and b3 are parameters associated with the decay of the time-decay function ƒ3(x)

In one embodiment, the item affinity estimation engine 116 is configured to combine contributions of each pair of items towards other items to estimate item relevancy scores of each of the items for the respective user. Furthermore, the recommendation engine 118 is configured to rank the items based on the item relevancy scores and to generate personalized recommendations for the respective user.

In one embodiment, recommender database 122 stores the contributory affinity values for each pair of items. In addition, the recommendation database 114 is configured to store the relevancy scores for each item present in the item catalogue for each user.

In an embodiment, the relevancy scores are rank ordered to obtain the top recommendations for the user. In further embodiment, the ranking is performed in decreasing order to obtain the top recommendations for the users. Moreover, the user interface 106 is used for transmitting the generated personalized recommendations to the users. In some examples, the user interface 106 may facilitate feedback, tuning and critiquing of the generated recommendations. In one embodiment, the user interface 106 may be an online portal or an offline channel.

In some embodiments, the item selection module 114 is configured to select pre-determined combinations of items purchased by each user at different purchase times from the purchase history 110 of the each of the one or more users to determine the contributory affinity values. In some examples, the maximum, average, minimum of affinity values or combination thereof may be selected, for the same item pair contribution by one or more users. In some embodiments, only the consecutive purchases corresponding to each item pair may be selected by the item selection module 114 for computing the contributory affinity values.

In one example, a user purchase history is represented by:

[(i1, t1), (i2, t2), (i3, t3) (i1, t4), (i2, t5), . . . ] (6)

Where i1, i2, i3, i4, i5 are items purchased at times t1, t2, t3, t4, t5 respectively; and

t1<=t2<=t3<=t4<=t5

then the contributory affinity resulting from (i1, t1) and (i2, t5) may not considered, whereas affinity resulting from (i2, t2) and (i1, t4) may be considered. Further, the contributory affinity value resulting from (i1, t1) and (i3, t3) pair may only be considered for computing the contributory affinity of the pair (i1, i3) but not (i3, i1), as purchase of i1 may lead to i3 but not vice-versa. It should be noted that the above selection of item-item pairs facilitates the directionality in the item-item pairs. In another embodiment, the item affinity estimation engine 116 is configured to select the contributory affinity value as zero for each item pair having same items to avoid same item getting recursive or self-boosted preference.

In some examples, the recommendation engine 118 is configured to generate recommendations for products that have not been purchased by the users yet. Moreover, the recommendation engine 118 is configured to generate recommendations for products that have not been purchased by the user in the recent time, or within a specified time period.

In some examples, different time-windows are selected for selecting the item training data set and for generating the personalized item rankings. For example, if the recommendations are required to be generated for the month of January 2017, then the item training data set may be selected for time period November 2015 to January 2016, and/or November 2016 to December 2016 and so forth. Further, the contributory affinity for pair of items may be contributed for each of these time periods. In some examples, each of these time periods may have their respective time-decay functions associated with them such as described above. Further, different reference times and weights may be selected for the selected training data. Further, contributory affinity values may be combined to obtain the resulting affinity value between the different items. Various combination techniques such as weighted linear function, conditional selection etc. may be used to estimate the resulting affinity values.

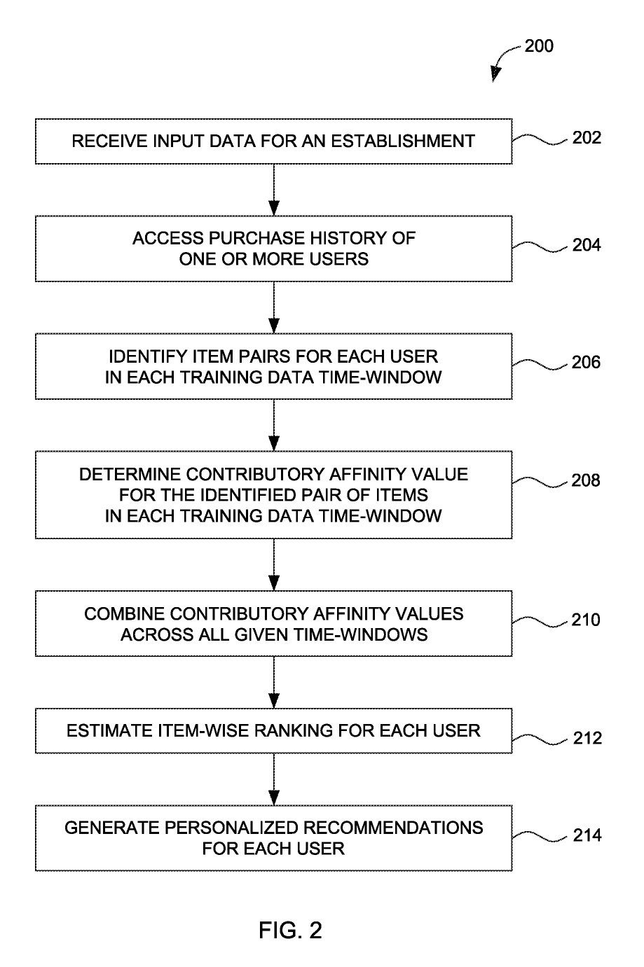

FIG. 2 illustrates an example process 200 for generating personalized recommendations for a user using the multi-window time-aware personalized recommendation system 100 of FIG. 1.

At step 202, input data for an establishment is received. The input data may include purchase history of one of more users/shoppers of the establishment and an item catalogue/item details of the items available for sale in the establishment. At step 204, the purchase history of one or more users of the establishment is accessed. In one embodiment, the purchase history is accessed from an enterprise memory. The purchase history may contain data such as transaction details, shopping cart activity, page views, product enquiries, searches among others.

At step 206, a plurality of item pairs from the items purchased by each user in each of training data time-window is identified and selected. The item pairs form an item training data set for determining item-item affinity for the item training data set. In an embodiment, each of the pair of items are selected from a plurality of items available in a retail store, listed on a web portal of a retail store, or combinations thereof.

At step 208, a contributory affinity value between the selected pair of items such as a first item and a second item in each of the training data time-window is determined. In an embodiment, the contributory affinity value is determined based on a first time-decay function and a second time-decay function associated with purchase times of the first and second items. In an embodiment, the first time-decay function ƒ1(x) is estimated based upon a time difference between purchases of the first item and the second item, in accordance with the relationship as stated in Equation (1). Similarly, the second time-decay function ƒ2(x) is estimated based upon a time difference between a reference time and a maximum of the purchase time of the first and second items, in accordance with the relationship as stated in Equation (2).

At step 210, the contributory affinity values for each of the one or more users across all given time-windows for the selected item pair are combined to estimate the affinity value between the first and second item. In this example, contributory affinity values for each user in each time-window are combined and the weighted combination across time-windows is determined to determine final item-item affinity values (possibly directional).

In an embodiment, the contributory affinity value is estimated between the first item i1 and the second item i2 purchased by a user at time t1 and t2 respectively and is given in accordance with the relationship as stated in Equation (3).

It should be noted that for each user, multiple values of A1 are estimated corresponding to the user's purchase of the first item i1 and the second item i2 at different points in time. The item affinity estimation engine 116 is configured to estimate a representative affinity value (RA1) using the multiple A1 values for the corresponding user. The representative affinity value may be a maximum value of A1's for that user, or an average value, or a minimum value, or a latest value. In operation, the representative affinity value (RA1) is estimated for the first item i1 and the second item i2 for all users for a given time-window. Such values are then summed up to determine the window affinity value (WA1) for that time-window. In some embodiments, for multiple time windows, final affinity value (FA) between the first item i1 and the second item i2 is estimated as a weighted combination of all individual window affinity values.

In one embodiment, the contributions of each pair of items towards other items are combined to estimate item relevancy scores of each of the items, for the respective user.

At step 212, an item ranking of each of the plurality of items available for sale is generated in a time-aware manner using users' purchase history. In an embodiment, the generated personalized item ranking is based on contribution of affinity of each item towards the rest of the items. In an embodiment, the contribution of the first item i1 purchased at a time t1 to each of the other items ik purchased at a time tk is given in accordance with the relationships as stated in Equations (4) and (5).

Furthermore, the items based on the item relevancy scores are rank ordered and personalized recommendations for the respective user is generated, at step 214. In an embodiment, the relevancy scores are rank ordered to obtain the top recommendations for the user. In further embodiment, the ranking is performed in decreasing order to obtain the top recommendations.

As described above, the parameters of the time-decay functions may be adjusted to have a desired shape and properties of the function based upon the type of establishment, products on sale and the types of users.

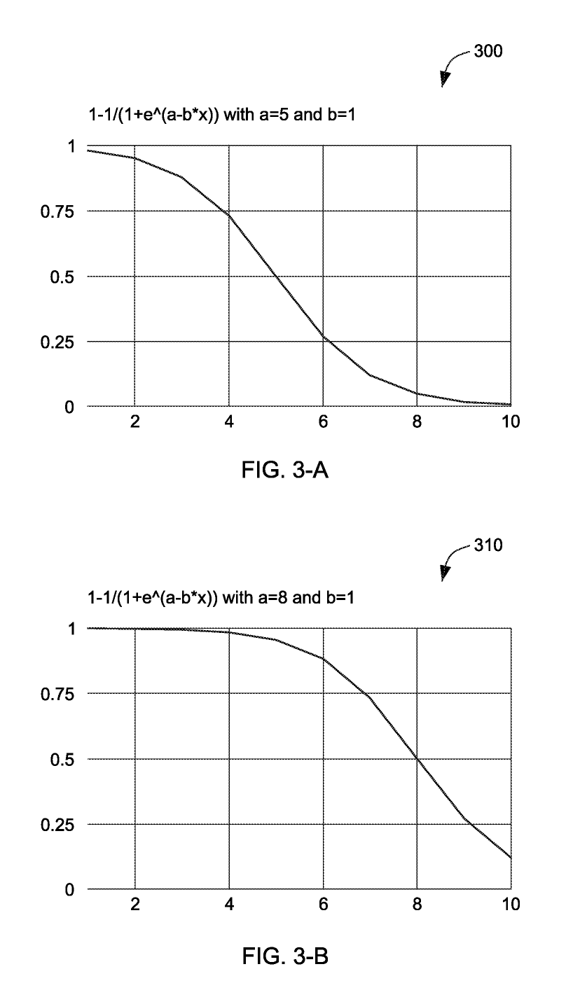

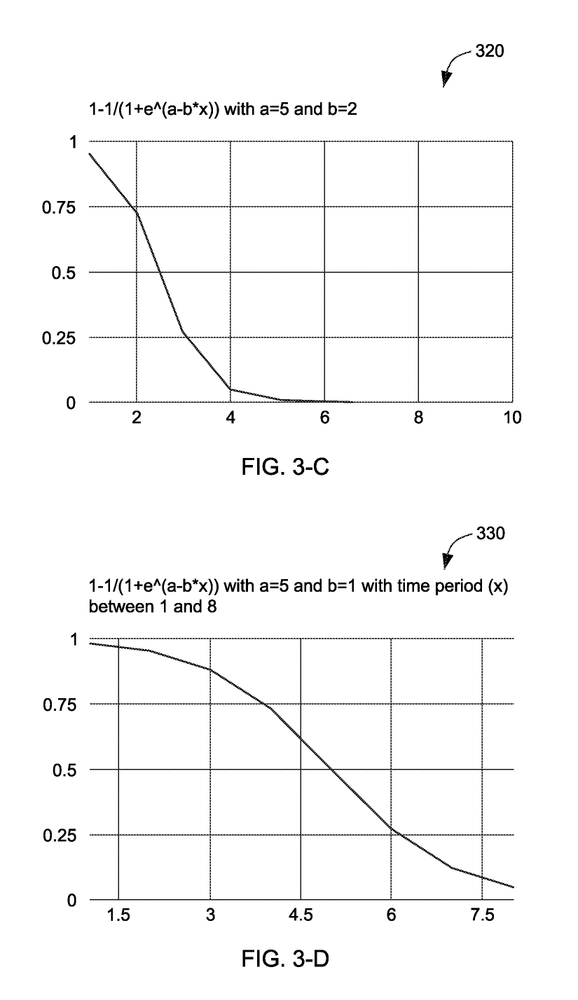

FIGS. 3-A through 3-D illustrate example time-decay functions with varying parameters, according to the aspects of the present technique.

FIG. 3-A illustrates an example time-decay function 300, according to the aspects of the present technique. In the illustrated embodiment, the time-decay function ƒ(x) is in accordance with the relationship:

ƒ(x)=1−1/(1+ê(a−b*x)) (7)

where a and b are the parameters associated with the decay of the time-decay function. In this example, the parameters a and b have values of 5 and 1 respectively. In the example functions illustrated below, a first half of the plots have a convex shape and the second halves have a concave shape. The time-decay function described with respect to the Equation 7 may cater to various cases such as, mostly convex, mostly concave, both convex and concave, and almost linear kind of curves as well. As can be seen in FIG. 3A, the time-decay function has a steady decrease over a period of time and has both convex and concave shapes.

FIG. 3-B illustrates an example time-decay function 310, according to the aspects of the present technique. In the illustrated embodiment, the time-decay function ƒ(x) is in accordance with the relationship stated in equation (7). In this example, the parameters a and b have values of 8 and 1 respectively. The time-decay function 310 is adjusted such that the function stays at a substantially constant value for an initial period of time and subsequently has a decrease.

FIG. 3-C illustrates an example time-decay function 320, according to the aspects of the present technique. In the illustrated embodiment, the time-decay function ƒ(x) is in accordance with the relationship stated in equation (7). In this example, the parameters a and b have values of 5 and 2 respectively. In this example, the time-decay function 320 is adjusted such that the value decreases over an initial period of time and subsequently has a value of about 0.

FIG. 3-D illustrates another time-decay function 330, according to the aspects of the present technique. In the illustrated embodiment, the time-decay function ƒ(x) is in accordance with the relationship stated in equation (7). In this example, the parameters a and b have values of 5 and 1 respectively, with time period (x) between 1 and about 8, that happens when the reference time t_{f} is outside the time-window under consideration. As can be seen, based upon a type of business, type of products sold and so forth, the parameters of the time-decay functions may be adjusted to adapt to different shapes.

In the above examples, the shape of the time-decay function ƒ(x) may have an inflexion point when a−b*x=0, thus changing from convex to concave, or vice versa. Here, the parameter a controls the convex part and parameter b controls the concave part of the function ƒ(x).

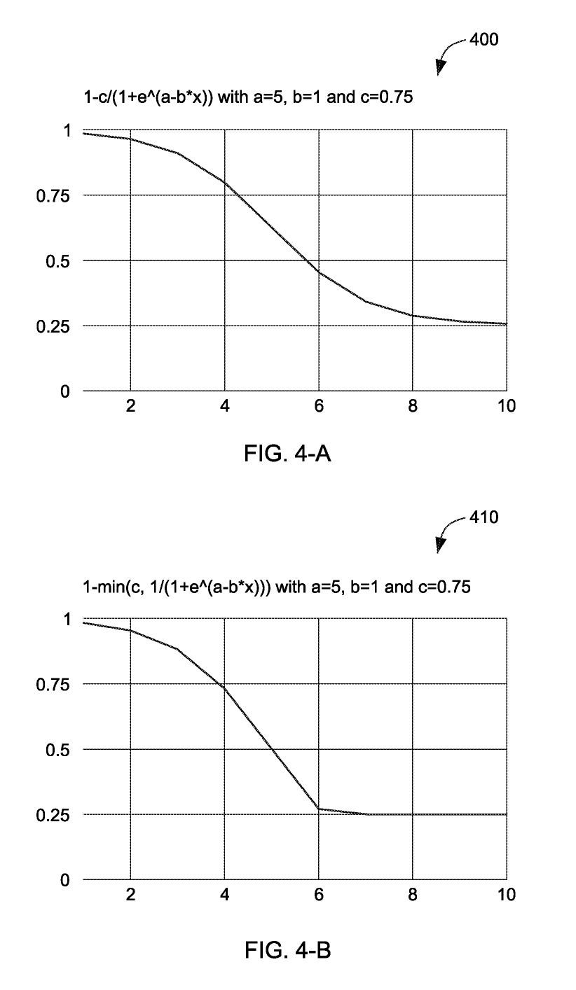

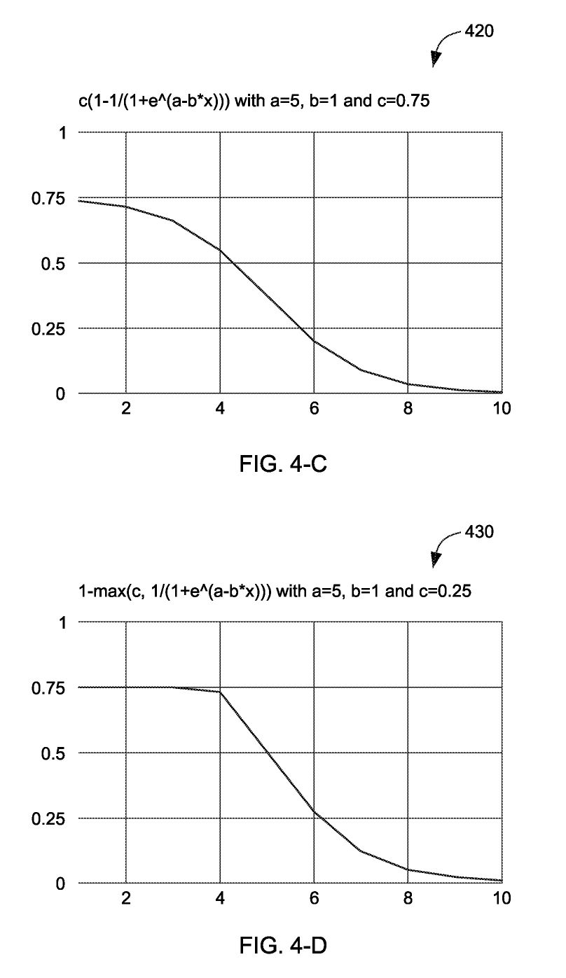

FIGS. 4-A through 4-D illustrate variations of the time-decay function, according to the aspects of the present technique. In an embodiment of the given variations, any constant such as k>1, may be used instead of the mathematical constant e. The parameters a and b can be chosen such that

ê(a−b*x)=k̂(a1−b1*x) (8)

for some a1 and b1.

FIG. 4-A illustrates a variation in time-decay function 400, according to an example embodiment. In the illustrated embodiment, the variation in time-decay function ƒ(x) is given in accordance with the relationship:

ƒ(x)=1−c/(1+ê(a−b*x)) (9)

where c belongs to [0,1]. In this example, the value of parameters a, b and c have values of 5, 2 and 0.75 respectively. The given variation helps in keeping the range of ƒ(x)in[1−c, 1], thereby maintaining the minimum value for ƒ(x) by scaling ƒ(x) accordingly.

FIG. 4-B illustrates a variation in time-decay function 410 in accordance with the relationship:

ƒ(x)=1−min(c, 1/(1+ê(a−b*x))) (10)

where c belongs to [0,1] and the value of the parameters a, b and c have values 5, 1 and 0.75 respectively.

FIG. 4-C illustrates a variation in time-decay function 420 in accordance with the relationship:

ƒ(x)=c(1−1/(1+ê(a−b*x))) (10)

where c belongs to [0,1] and the value of the parameters a, b and c have values 5, 1 and 0.75 respectively.

FIG. 4-D illustrates a variation in time-decay function 430, according to an example embodiment. In the illustrated embodiment, the variation in time-decay function ƒ(x) is given in accordance with the relationship:

ƒ(x)=1−max(c, 1/(1+ê(a−b*x))) (10)

where c belongs to [0,1]. In this example, the value of parameters a, b and c have values 5, 1 and 0.25 respectively. The given variation helps in keeping the range of ƒ(x) in [0,1−c] by the method of hard thresholding.

The above illustrated variations of the proposed time-decay function may be used to reduce the cross validation/test errors. It should be noted that the present technique allows flexibility in recommending only items which were not previously purchased by the user (not purchased in the recent time or a given time period) or consider only the items which have already been purchased by the user at some point in time or a mix or combination of both. In an embodiment, apart from the parameters described above for learning and personalized rankings for the items, the time periods from which the data is chosen for training and for personalized ranking can be varied.

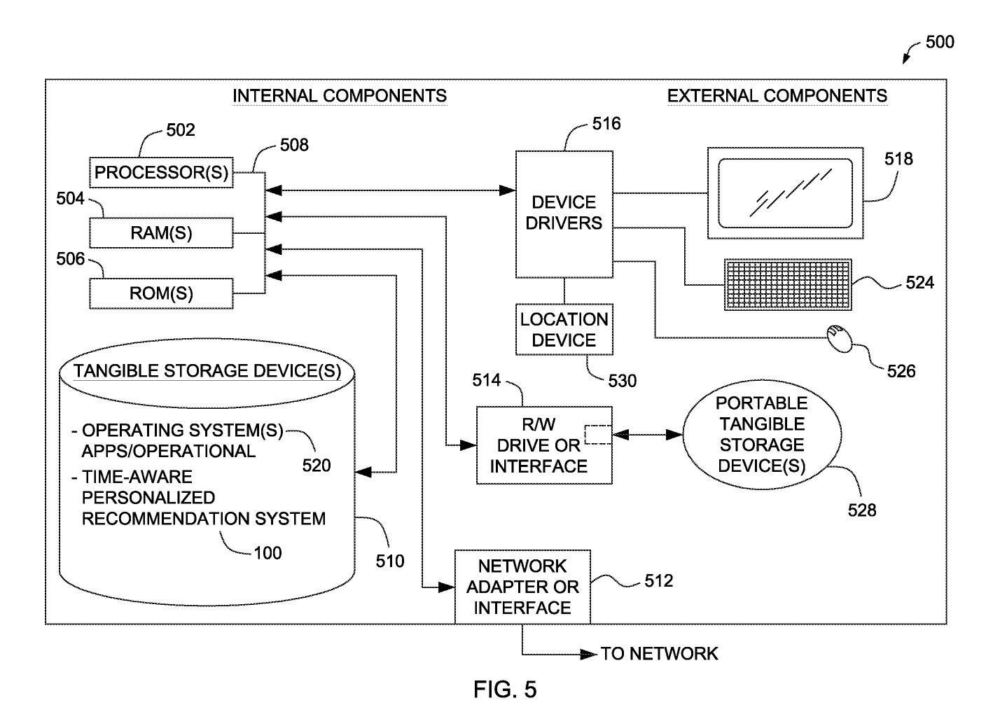

The modules of the multi-window time-aware personalized recommendation system 100 described herein are implemented in computing devices. One example of a computing device 500 is described below in FIG. 5. The computing device includes one or more processor 502, one or more computer-readable RAMs 504 and one or more computer-readable ROMs 506 on one or more buses 508. Further, computing device 500 includes a tangible storage device 510 that may be used to execute operating systems 520 and the multi-window time-aware personalized recommendation system 100. The various modules of the multi-window time-aware personalized recommendation system 100 including a processor 102, an enterprise memory 104 and a user interface 106 may be stored in tangible storage device 510. Both, the operating system 520 and the system 100 are executed by processor 502 via one or more respective RAMs 504 (which typically include cache memory). The execution of the operating system 520 and/or the system 100 by the processor 502, configures the processor 502 as a special purpose processor configured to carry out the functionalities of the operation system 520 and/or the multi-window time-aware personalized recommendation system 100, as described above.

Examples of storage devices 510 include semiconductor storage devices such as ROM 506, EPROM, flash memory or any other computer-readable tangible storage device that may store a computer program and digital information.

Computing device also includes a R/W drive or interface 514 to read from and write to one or more portable computer-readable tangible storage devices 528 such as a CD-ROM, DVD, memory stick or semiconductor storage device. Further, network adapters or interfaces 512 such as a TCP/IP adapter cards, wireless Wi-Fi interface cards, or 3G or 4G wireless interface cards or other wired or wireless communication links are also included in computing device.

In one example embodiment, the multi-window time-aware personalized recommendation system 100 which includes a processor 102, an enterprise memory 104 and a user interface 106, may be stored in tangible storage device 510 and may be downloaded from an external computer via a network (for example, the Internet, a local area network or other, wide area network) and network adapter or interface 512.

Computing device further includes device drivers 516 to interface with input and output devices. The input and output devices may include a computer display monitor 518, a keyboard 524, a keypad, a touch screen, a computer mouse 526, and/or some other suitable input device.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this

1. A multi-window time-aware personalized recommendation system, the system comprising:
a memory having computer-readable instructions stored therein; and
a processor configured to:
access purchase history of one or more users;
select a pair of items purchased by the one or more users based on the purchase history,
determine a contributory affinity value between a first item and a second item of the selected pair of items for each of the one or more users; wherein the contributory affinity value is determined based on a first time-decay function and a second time-decay function associated with purchase times of the first and second items; and
combine the contributory affinity values for each of the one or more users to estimate the affinity value between the first and second item.

2. The multi-window time-aware personalized recommendation system of claim 1, wherein the processor is further configured to execute the computer-readable instructions to:
estimate the first time-decay function based upon a time difference between purchases of the first item and the second item; and
estimate the second time-decay function based upon a time difference between a reference time and a maximum of the purchase time of the first and second items.

3. The multi-window time-aware personalized recommendation system of claim 1, wherein the processor is further configured to execute the computer-readable instructions to select the pair of items from a plurality of items available in a retail store, listed on a web portal of a retail store, or combinations thereof.

4. The multi-window time-aware personalized recommendation system of claim 1, wherein the processor is further configured to execute the computer-readable instructions to estimate the first time-decay function ƒ(x) based upon a time difference between purchases of the first item and the second item, in accordance with the relationship:
ƒ1(x)=1−1/(1+ê(a1−b1*x)), where a1 and b1 are parameters associated with the decay of the first time-decay function ƒ1(x).

5. The multi-window time-aware personalized recommendation system of claim 1, wherein the processor is further configured to execute the computer-readable instructions to estimate the second time-decay function ƒ2(x) based upon a time difference between a reference time and a maximum of the purchase time of the first and second items, in accordance with the relationship:
ƒ2(x)=1−1/(1+ê(a2−b2*x)), where a2 and b2 are parameters associated with the decay of the second time-decay function ƒ2(x).

6. The multi-window time-aware personalized recommendation system of claim 1, wherein the processor is further configured to execute the computer-readable instructions to estimate the contributory affinity value (A1) between the first item i1 and the second item i2 purchased by a user at time t1 and t2 respectively in accordance with the relationship:
A1=ƒ1(|t1−t2|)*ƒ2(|tƒ−max(t1, t2)|), where ƒ1 and ƒ2 are the first and second time-decay functions respectively and tƒ is the reference time.

7. The multi-window time-aware personalized recommendation system of claim 1, wherein the processor is further configured to execute the computer-readable instructions to: estimate a plurality of values of the contributory affinity value (A1) corresponding to the user's purchase of the first item i1 and the second item i2 at different points in time of a time-window;
estimate a representative affinity value (RA1) using the multiple A1 values for the corresponding user;
determine a window affinity value (WA1) for the time-window based on the representative affinity value for the user; and
estimate a final affinity value (FA) between the first item i1 and the second item i2 based on a weighted combination of the individual window affinity values.

8. The multi-window time-aware personalized recommendation system of claim 7, wherein the processor is further configured to execute the computer-readable instructions to select items purchased corresponding to an average, maximum, minimum, or latest of purchase times combinations by each of the one or more users to determine the contributory affinity value between the first item and the second item of each of the selected pair of items.

9. The multi-window time-aware personalized recommendation system of claim 1, wherein a value of the first and second time-decay functions is between 0 and about 1.

10. The multi-window time-aware personalized recommendation system of claim 1, wherein the processor is further configured to execute the computer-readable instructions to generate a personalized item ranking of each of the plurality of items for each user based on contribution of affinity of each item in the purchase history of the respective user towards the rest of the items, wherein the contribution of the first item i1 purchased at a time t1 to each of the other items ik in accordance with the relationship:
FA(i1, ik)*ƒ3(|tƒ−t1|), where FA(i1, ik) is multi-window affinity between i1 and ik, ƒ3(x) is a time-decay function and tf is a reference time.

11. The multi-window time-aware personalized recommendation system of claim 10, wherein the processor is further configured to execute the computer-readable instructions to estimate the time-decay function ƒ3(x) in accordance with the relationship:
ƒ3(x)=1−1/(1+ê(a3−b3*x))

12. The multi-window time-aware personalized recommendation system of claim 10, wherein the processor is further configured to execute the computer-readable instructions to combine the contributions of each pair of items towards other items to estimate item relevancy scores of each of the items for the respective user.

13. The multi-window time-aware personalized recommendation system of claim 12, wherein the processor is further configured to execute the computer-readable instructions to rank the items based on the item relevancy scores and to generate personalized recommendations for the respective user.

14. The multi-window time-aware personalized recommendation system of claim 12, further comprising a user interface to transmit the generated personalized recommendations to the user.

15. The multi-window time-aware personalized recommendation system of claim 1, wherein the processor is further configured to execute the computer-readable instructions to adjust parameters of the first, second and third time-decay functions such that the first, second and third time-decay functions have a concave, a convex shape, or combinations thereof.

16. A method for generating personalized recommendations for a user, the method comprising:
accessing purchase history of one or more users of an establishment;
selecting an item training data set for determining item-item affinity for the item training data set;
identifying a plurality of item pairs for each user in the item training data set based upon the purchase history of the respective user;
determining a contributory affinity value between a first item and a second item of each of the item pairs for each user; wherein the contributory affinity value is determined based on a first time-decay function and a second time-decay function associated with purchase times of the first and second items;
combining the contributory affinity values for each user to estimate the affinity value between the first and second item of each of the item pairs;
generating a personalized item ranking of each of the plurality of items for each user based on contribution of affinity of each item in the purchase history of the respective user; and
generating personalized recommendations for each user based on the generated item ranking of each of the plurality of items.

17. The method of claim 16, wherein determining the contributory affinity value further comprises:
estimating the first time-decay function based upon a time difference between purchases of the first item and the second item; and
estimating the second time-decay function based upon a time difference between a reference time and a maximum of the purchase time of the first and second items.

18. The method of claim 16, wherein generating the personalized recommendations further comprises combining contributions of each pair of items towards other items to estimate item relevancy scores of each of the plurality of items and generating the personalized recommendations based on the item relevancy scores.

19. The method of claim 16, wherein determining a contributory affinity value further comprises:
estimating the first time-decay function ƒ1(x) in accordance with the relationship:
ƒ1(x)=1−1/(1+ê(a1−b1*x)), where a1 and b1 are parameters associated with the decay of the first time-decay function ƒ1(x);
estimating the second time-decay function ƒ2(x) in accordance with the relationship:
ƒ2(x)=1−1/(1+ê(a2−b2*x)), where a2 and b2 are parameters associated with the decay of the second time-decay function ƒ2(x); and
estimating the contributory affinity value (A1) between the first item i1 and the second item i2 purchased by a user at time t1 and t2 respectively in accordance with the relationship:
A1=ƒ1(|t1−t2|)*ƒ2(|tƒ−max(t1, t2)|), where ƒ1 and ƒ2 are the first and second time-decay functions respectively and tƒ is the reference time.

20. The method of claim 16, further comprising:
selecting a plurality of item training data sets corresponding to different time periods;
selecting time-decay functions corresponding to the different time periods;
determining a contributory affinity value between a first item and a second item of each of the item pairs of the item training data sets for each user for the different time periods using the selected time-decay functions; and
combining the contributory affinity values for each user to estimate the affinity value between the first and second item of each of the item pairs.

21. A multi-window time-aware personalized recommendation system, the system comprising:
a memory having computer-readable instructions stored therein; and
a processor configured to:
access purchase history of one or more users;
apply a time-decay based item-item collaborative filtering to a plurality of items based upon the purchase history of each of the one or more users;
estimate affinity values between pairs of items for each of the one or more users;
generate personalized item ranking for each of the plurality of items for each user based on contribution of affinity of each item in the purchase history of the respective user towards all items in a catalogue; and
generate personalized recommendations for each of the one or more users based on the generated item ranking.

22. The multi-window time-aware personalized recommendation system of claim 21, wherein the processor is further configured to execute the computer-readable instructions to:
select a pair of items purchased by the one or more users based on the purchase history,
determine a contributory affinity value between a first item and a second item of the selected pair of items for each of the one or more users; wherein the contributory affinity value is determined based on a first time-decay function and a second time-decay function associated with purchase times of the first and second items; and
combine the contributory affinity values for each of the one or more users to estimate the affinity value between the first and second item.
